(19) United States
(12) Patent Application Publication
(10) Pub. No.: US 2013/0041662 A1
(43) Pub. Date: Feb. 14, 2013

(54) SYSTEM AND METHOD OF CONTROLLING SERVICES ON A DEVICE USING VOICE DATA

(71) Applicant: Sriram Sampathkumaran, San Diego, CA (US)

(72) Inventor: Sriram Sampathkumaran, San Diego, CA (US)

(73) Assignee: Sony Corporation

(21) Appl. No.: 13/205,069

(22) Filed: Aug. 8, 2011

(51) Int. Cl. G10L 15/26

(52) U.S. Cl. 704/235; 704/E15.043

(57) ABSTRACT

A device and method to control applications using voice data. In one embodiment, a method includes detecting voice data from a user, converting the voice data to text data, matching the text data to an identifier the identifier associated with a list of identifiers for controlling operation of the application, and controlling the application based on the identifier matched with the text data. In another embodiment, voice data may be received from a control device.

### FIELD

The present disclosure relates generally to electronic device control, and more particularly to methods and an apparatus for controlling services on an electronic device using voice data.

### BACKGROUND

Home electronic devices may include many features in addition to display of broadcast television. Some of these features may be network based services. Conventionally, users of these home electronic devices use remote controls to control device operations. Remote controls, however, often lack the ability to allow a user to quickly search for certain features provided by the home electronic device. Similarly, remotes do not allow for control of network based services. As a result, conventional remote controls provide access to limited features. Thus, one or more solutions are desired to allow users to control features provided by home electronic devices, such as network based services.

### BRIEF SUMMARY OF EMBODIMENTS

Disclosed and claimed herein are methods and an apparatus for controlling applications on a device. In one embodiment, a method includes detecting voice data from a user, converting the voice data to text data, matching the text data to an identifier, the identifier associated with a list of identifiers for controlling operation of at least one of the applications, and controlling the at least one of the applications based on the identifier matched with the text data. In another embodiment, the act of acquiring voice data is performed by a control device, which then sends the data to the main device.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a simplified block diagram of a device according to one or more embodiments;

FIG. 2 depicts a process for controlling services on a device according to one or more embodiments;

FIGS. 3A-3B depict a display containing a text box according to one or more embodiments; and

FIG. 4 depicts a simplified system diagram according to one or more embodiments.

### DETAILED DESCRIPTION OF EXEMPLARY EMBODIMENTS

### Overview and Terminology

One aspect of the disclosure relates to controlling operation of a device based on detected voice commands. In one embodiment, detected voice data may be employed to control an application running on an audio/video device such as a television. A method is provided for detecting voice data from a user, matching the voice data to an identifier, and controlling an application based on the matched identifier. One advantage of the embodiments described herein may be the ability to use voice commands to launch and operate network based services, which include applications and content. Services may include network based applications such as email services, social networking services, video sharing services, news services, and others. Content may include videos, audio, pictures, and text in a variety of formats, from various channels. In certain embodiments, a secondary device may be employed to acquire voice data, convert the voice data to text, and send the text data to the device to control the services.

In one embodiment, a method is provided for detecting voice data from a user and converting the voice data to text data. The method may include matching text data to an identifier associated with a list of identifiers for controlling operation of at least one of the applications, and controlling the at least one application based on the matched identifier. Voice data may be used to control the services, in contrast to conventional methods for controlling services.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

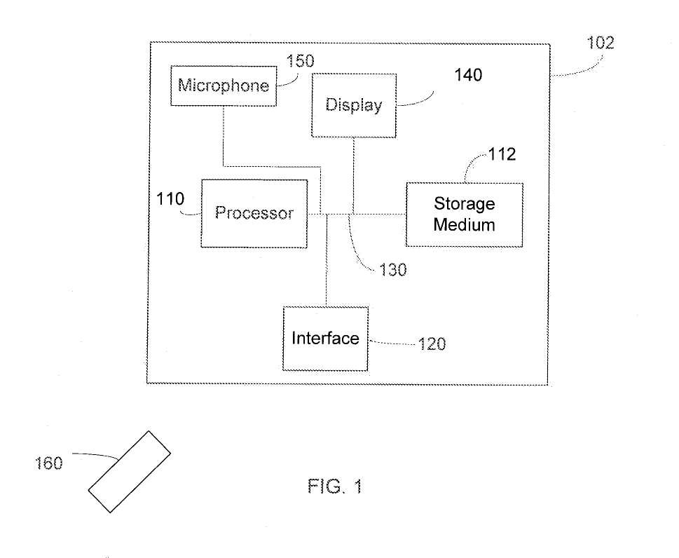

Referring now to FIG. 1, a simplified block diagram is depicted of a device according to one embodiment. Device 102 may relate to an audio/video device configured to provide and display services, such as networked based services that include applications and content as well as other applications and content. Device 102 may relate to one or more of a display device, computer device, gaming system, communication device, or tablet. As depicted in FIG. 1, device 102 includes processor 110, storage medium 112, input/output (I/O) interface 120, communication bus 130, display 140, and microphone 150. Elements of device 102 may be configured to communicate and interoperate by communication bus 130. Processor 110 may be configured to control operation of device 102 based on one or more computer executable instructions stored in storage medium 112. In one embodiment, processor 110 may be configured to run an operating platform, such as an operating system. Furthermore, processor 110 may run applications on the operating platform. For example, processor 110 may run or control one or more applications that provide network based services, which include applications and content, as well as other applications and content, on the operating platform. Storage medium 112 may relate to one of RAM and ROM memories and may be configured to store the operating systems, one or more applications, and other computer executable instructions for operation of device 102. Although depicted as a single memory unit, storage medium 112 may relate to one or more of internal device memory and removable memory.

I/O interface 120 may be employed to communicate with processor 110 and control operation of device 102. I/O interface 120 may include one or more buttons for user input, such as a numerical keypad, volume control, menu controls, pointing device, track ball, mode selection buttons, and playback functionality (e.g., play, stop, pause, forward, reverse, slow motion, etc). Buttons of I/O interface 120 may include hard and soft buttons, wherein functionality of the soft buttons may be based on one or more applications running on device 102. I/O interface 120 may include one or more elements to allow for communication by device 102 by wired or wireless communication. For example, I/O interface 120 may allow for communication with the device through remote 160. Remote 160 may wirelessly send data to device 102 to control operation of device 102.

I/O interface 120 may also include one or more ports for receiving data, including ports for removable memory. I/O interface 120 may be configured to allow for network-based communications including but not limited to LAN, WAN, Wi-Fi, Bluetooth, etc. I/O interface 120 may allow device 102 to access network applications/services and to display services on display 140, such as applications and content, found on the internet. For example, in one embodiment, device 102 may run a main application that displays various services to a user. The services may be entertainment network based applications, such as, email services, social networking services, video sharing services, or numerous other entertainment applications. Other network based applications, such as, maps, news feeds, weather feeds, and other applications may also be displayed. Furthermore, in another embodiment, device 102 may run a main application that displays content to a user. The main application may display entertainment content such as video, audio, or pictures. In yet another embodiment, the main application may display both applications and content to a user by way of display 140.

Display 140 may be employed to display one or more applications executed by processor 110. In certain embodiments, display 140 may relate to a touch screen display and operate as an I/O interface. Microphone 150 may be configured to detect voice data and other audio data from a user or another source.

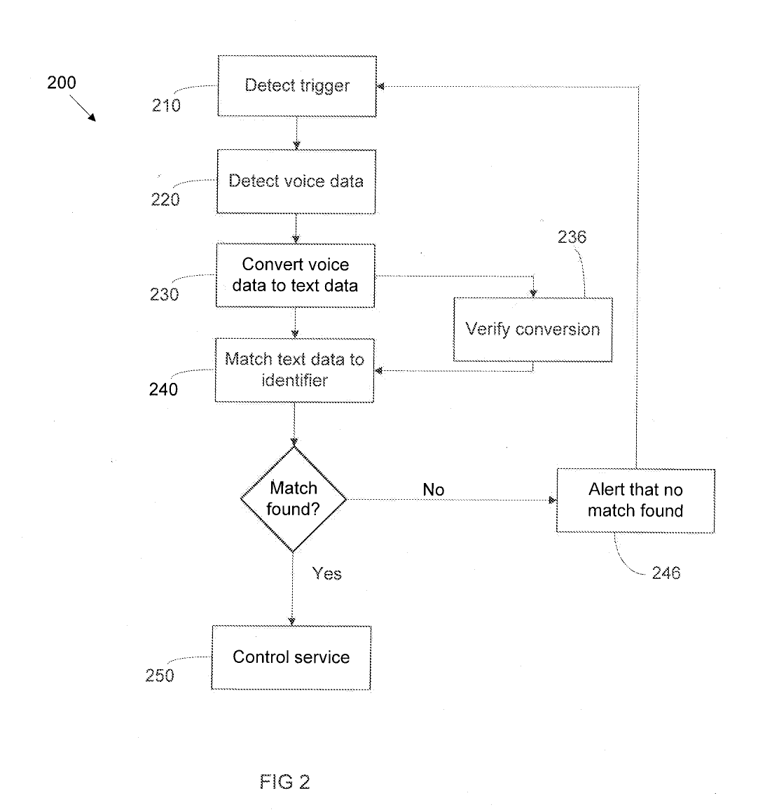

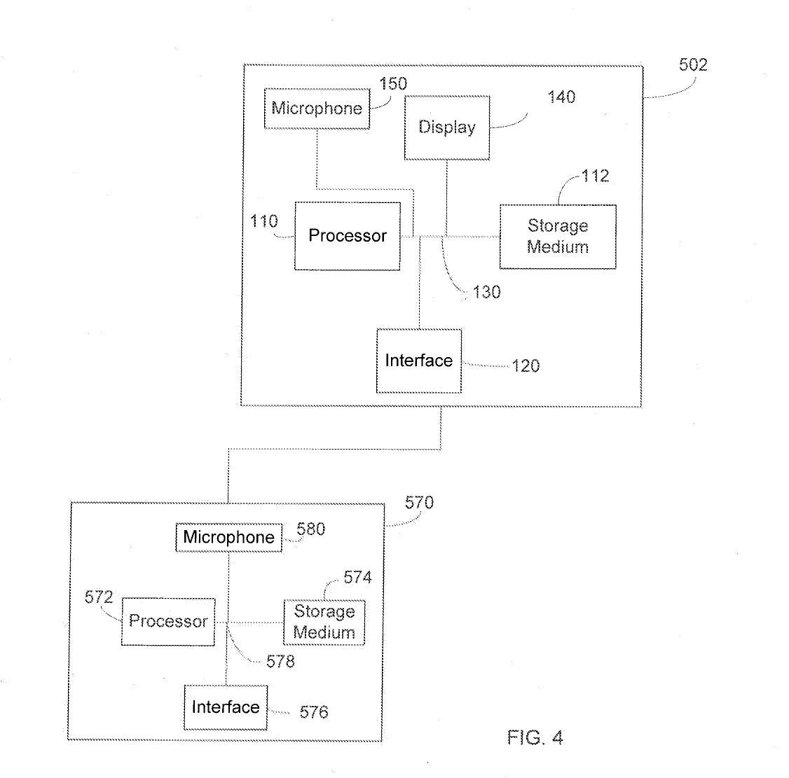

Referring now to FIG. 2, a process is depicted for controlling services provided on a device. Process 200 may be employed to control the services, such as, network based services, which include applications and content, as well as other applications and content on a device using the voice of a user. In one embodiment, process 200 may be employed by the device of FIG. 1. In another embodiment, process 200 may be employed by the display device and control device of FIG. 4.

In one embodiment, process 200 may be initiated when a device (e.g. device 102) detects a trigger at block 210. The trigger may indicate to the device that a user is ready to speak identifier words that may be used by the device to control the services provided on the device. Detecting the trigger at block 210 may include detecting an input through an I/O interface (e.g., I/O interface 120). In one embodiment, the detected trigger may originate from a hard or soft buttons on an I/O interface. In another embodiment, the detected trigger may originate from a remote.

In another embodiment, process 200 may be initiated when a control device, which is used to control a display device that provides and displays services, detects a trigger at block 210. The trigger may indicate to the control device that a user is ready to speak identifier words that may be used by the display device to control services provided on the display device. Detecting the trigger at block 210 may include detecting an input through an I/O interface. In one embodiment, the detected trigger may originate from a hard or soft buttons on an I/O interface.

In one embodiment, a device may be configured to detect an audio command, such as a voice command based on a detected trigger. At block 220, voice data may be detected. Voice data may be detected utilizing a microphone. The detected voice data may be processed, digitized, and stored in a storage medium.

In another embodiment, a control device used to control a display device may be configured to detect an audio command, such as a voice command based on a detected trigger. At block 220, voice data may be detected. Voice data may be detected utilizing a microphone. The detected voice data may be processed, digitized, and stored in a storage medium of the control device. The control device may then send the voice data to the display device and process 200 may continue on the display device. Alternatively, the control device may not send the voice data to the display device and process 200 may continue on the control device.

Once the voice data is detected at block 220, the detected voice data is converted to text data at block 230. The voice data may be converted to text data using a speech to text application or algorithm. For example, in one embodiment, the voice data may be converted to text data using the speech to text application available on an operating system of a device. It should be understood that many different applications and algorithms may be used to convert the voice data to text data.

In another embodiment, the voice data may be converted to text data at block 230 using the speech to text application available on an operating system of a control device. The control device may then send the voice data to the display device and process 200 may continue on the display device.

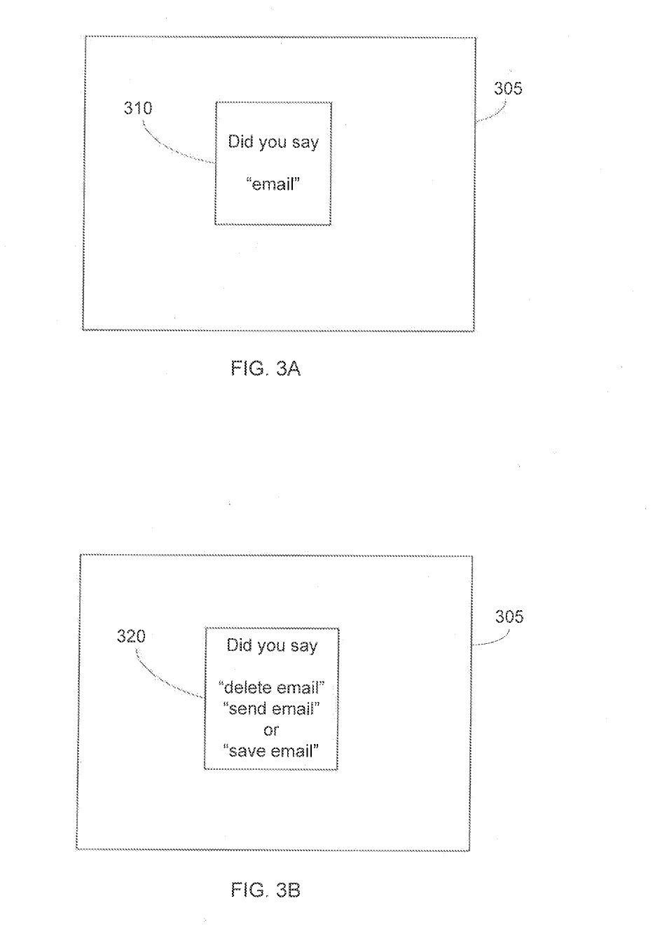

Once the voice data is converted to text data at block 230, the voice to text conversion may be verified at block 236. At block 236, the voice to text conversion may be verified by a user. The conversion may be verified by the user by first displaying the converted text on a display (e.g. display 140), as depicted in FIG. 3A. Once the converted text is displayed, the user may indicate if the text conversion was properly performed by sending a signal to a processor (e.g. processor 110) by way of a microphone (e.g. microphone 150), an I/O interface (e.g. I/O interface 120), a remote (e.g. remote 160), or other means.

In some situations, the voice to text data conversion at block 230 may produce multiple text strings. For example, a user may say the word “email” and the voice to text application or algorithm may generate two or more alternative text strings such as “delete email,” “send email,” or “save email,” as depicted in FIG. 3B. In these situations, a user may indicate which text string is correct by sending a signal to a processor (e.g. processor 110) by way of a microphone (e.g. microphone 150), an I/O interface (e.g. I/O interface 120), a remote (e.g. remote 160), or other means.

At block 240, text data is matched with an identifier that is associated with a list of identifiers for controlling operations of services, such as network based services, which include applications and content. The listing of identifiers may contain identifiers associated with the provided services. The listing of identifiers may also contain identifiers associated with actions that control the provided services. For example, the identifiers may include the actions of playing, pausing, stopping, or traversing content. The identifiers may further include the actions of navigating, selecting, or interacting with applications. In short, the listing of identifiers may include identifiers that correspond to any action that could be performed with another form of input on services such as network based services, which include applications and content. Furthermore, it should be understood that the listing of identifiers is not static. The listing of identifiers may be updated, augmented, or otherwise changed when content or an application provided by the network based services or otherwise is updated or changed.

In another embodiment, the listing of identifiers may be updated, augmented, or otherwise changed when content or an application are selected to allow for actions and information within the selected content or application to be included in the listing of identifiers. For example, if an application is selected, the listing of identifiers may be augmented to include names of the content provided by and commands associated with the selected application. In another embodiment, the listing of identifiers may be updated, augmented, or otherwise changed to incorporate actions and information within content or applications before they are selected by a user. In another embodiment, the listing of identifiers may include identifiers associated with user generated commands. For example, a user may specify that the phrase “3×” may be associated with the command to fast forward content at 3× speed.

Referring again to FIG. 2, at block 240, the text data may be matched with an identifier within the list of identifiers using a matching algorithm. In one embodiment, the matching algorithm may use strict string matching and only match the text data with an identifier if all of the characters in the identifier match the text data. Alternatively, the matching algorithm may match the text data with an identifier if one or more characters in the identifier do not match the text data. It should be understood that any matching algorithm that is able to match characters from the text data with characters in identifiers may be used. It should also be understood that the number of accurately matched characters needed to match the text data with an identifier may also vary.

In certain embodiments where text data is not verified and more than one text string is produced from the conversion from voice data to text data, process 200 may attempt to match the provided text strings until one text string matches an identifier. Alternatively, process 200 may attempt to match every provided text string with an identifier. In this situation, if more than text string matches an identifier, process 200 may verify with the user which text string is the correct conversion of the voice data received at block 220. The process 200 may verify with the user by displaying the multiple text strings to the user as depicted in FIG. 3B and allowing the user to indicate the correct text string.

If the text data is matched with an identifier from the list of identifiers, process 200 proceeds to block 250. If the text data is not matched with an identifier from the list of identifiers, process 200 proceeds to block 246. At block 246, the user is notified that an identifier was not matched to the text data. The user may be notified by displaying a text box on a display (e.g. display 140). Alternatively, the user may be notified by a change in the visual appearance of a display, such as one or more of pulsing, fading, flashing, or undergoing other changes. Alternatively, an audio recording, such as a beep, tone, or voice recording, may indicate to the user that the voice data was not matched with an identifier at block 240. It should be understood that a variety of ways might be used to notify the user that a match was not made between the voice data and the list of identifiers. After notifying the user that an identifier was not matched to the text data at block 246, process 200 may return to block 210 to await another trigger.

With the text data matched to an identifier, process 200 controls one of the services provided by the application at block 250 according to the identifier matched with the text data. Each identifier within the list of identifiers may be associated with a command for controlling the services provided by the main application. Each identifier within the list of identifiers may be associated to a certain API (i.e., application programming interface) for the provided services. The name of a service, such as an application, may be an identifier that is associated with the command to launch the application. Here, the identifier may be linked to the API to launch an application. For example, if the identifier matched with the text data is the word “email,” then process 200 may launch an email application using a device (e.g. device 102) and display the application on a display (e.g. display 140). Furthermore, the name of content, such as music content, may be an identifier that is associated with the command to launch the music content.

For example, if the identifier matched with the text data is the word “mozart,” then process 200 may launch music composed by “mozart”.

Additional identifiers, besides the names of a service, may also be included in the list of identifiers. Words such as “play,” “pause,” “stop,” “next,” “back,” “forward,” “close,” and a host of other words associated with navigating and controlling services, channels, and sub-features may be used as identifiers. These identifiers may be matched with text data during process 200. After being matched with text data process 200 may control services according to the matched identifier at block 250. For example, if a movie was being displayed and the identifier matched with the text data is “pause,” then the movie may be paused. In another example, if an application had been launched, such as email, and the identifier matched with the text data is “close,” then the email may be closed. Process 200 thus enables a user to use their voice to control network based services, applications, content, or any combination of the three on a device.

Referring now to FIG. 3A, an exemplary display window containing a text block is depicted according to one embodiment. Text block 310 may contain text data converted from voice data. For example, if a voice command stated “email,” the voice data may be converted to text data of “email” and displayed to a user in text block 310 on display 305.

FIG. 3B depicts a display that contains a text block according to one embodiment. Text block 320 may contain multiple text strings that result from voice to text data conversion. For example, if a voice command stated “email,” the algorithm or application that converts the voice data to text data may generate two or more alternative text strings such as “delete email,” “send email,” or “save email.” All three of these text strings may be displayed to a user in text block 320 on display 305.

Referring now to FIG. 4, a simplified block diagram is depicted of a device and a control device according to one embodiment. Device 502 may relate to an audio/video device configured to provide networked based services that included applications and content as well as other applications and content. Device 502 may relate to one or more of a display device, computer device, gaming system, communication device, or tablet. Control device 570 may relate to an audio/video device configured to control device 502. Control device 570 may relate to one or more of a computer device, gaming system, communication device, tablet, or display device control.

As depicted in FIG. 4, device 502 may employ the device of FIG. 1 and include the processor 110, storage medium 112, input/output (I/O) interface 120, communications bus 130, and display 140.

As further depicted in FIG. 4, control device 570 includes processor 572, storage medium 574, input/output (I/O) interface 576, communication bus 578, and microphone 580. Elements of control device 570 may be configured to communicate and interoperate by communication bus 578. Processor 572 may be configured to control operation of control device 570 based on one or more computer executable instructions stored in storage medium 574. In one embodiment, processor 572 may be configured to run an operating platform, such as, an operating systems. Furthermore, processor 572 may run and control one or more applications on the operating platform. For example, processor 572 may run applications that convert voice data to text data. Storage medium 574 may relate to one of RAM and ROM memories and may be configured to store the operating systems, one or more applications, and other computer executable instructions for operation of control device 570. Although depicted as a single memory unit, storage medium 574 may relate to one or more of internal device memory and removable memory.

Microphone 580 may be configured to detect voice data and other audio data from a user or another source. I/O interface 576 may be employed to communicate with the processor 572. I/O interface 576 may include one or more buttons for user input, such as a numerical keypad, volume control, menu controls, pointing device, track ball, mode selection buttons, and playback functionality (e.g., play, stop, pause, forward, reverse, slow motion, etc). Buttons of I/O interface 576 may include hard and soft buttons, wherein functionality of the soft buttons may be based on one or more applications running on control device 570. I/O interface 576 may include one or more elements to allow for communication by control device 570 by wired or wireless communication. For example, I/O interface 576 may allow for communication between device 502 and control device 570. For example, control device 570 may send data wireless to device 502 to control operation of device 502. I/O interface 520 may also include one or more ports for receiving data, including ports for removable memory. I/O interface 520 may be configured to allow for network-based communications including but not limited to LAN, WAN, Wi-Fi, Bluetooth, etc.

While this disclosure has been particularly shown and described with references to exemplary embodiments thereof, it will be understood by those skilled in the art that various changes in form and details may be made therein without departing from the scope of the embodiments encompassed by the appended claims.

What is claimed is:

1. A method for controlling one or more applications on a device, the method comprising the acts of:
detecting, by the device, voice data;
converting the voice data to text data;
matching the text data to an identifier, the identifier associated with a list of identifiers for controlling operation of at least one of the applications; and
controlling, by the device, the at least one application based on the identifier matched with the text data.

2. The method of claim 1, wherein the converting includes transmitting the text data to a network based service for voice to text conversion.

3. The method of claim 1, wherein the voice data is received from a control device.

4. The method of claim 1, wherein the device is one of a television remote, a tablet, a mobile phone, a personal digital assistant, a video player, and a music player.

5. The method of claim 1, wherein the text data is matched to the identifier using character matching.

6. The method of claim 1, wherein each identifier is associated with a command for controlling at least one of the applications.

7. The method of claim 6, wherein a name of each application is an identifier that is associated with a command to launch at least one of an application, a channel, a service, and a sub-feature.

8. The method of claim 1, wherein controlling the application includes navigating through the at least one application.

9. The method of claim 1, wherein controlling the application includes at least one of playing, pausing, stopping, and traversing content within the application.

10. The method of claim 1, further comprising displaying the text data when the text data is matched to a plurality of identifiers, and receiving confirmation from the user that the text data represents the voice data.

11. The method of claim 1, further comprising notifying a user if the text data is not matched to an identifier.

12. A computer program product comprising a computer readable medium having non-transitory computer readable code tangibly embodied thereon that, when executed, causes a computer to control one or more applications on a device, the code comprising:
computer readable code to detect voice data;
computer readable code to convert the voice data to text data;
computer readable code to match the text data to an identifier, the identifier associated with a list of identifiers for controlling operation of at least one of the applications; and
computer readable code to control the at least one of the applications based on the identifier matched with the text data.

13. The computer program product of claim 12, wherein the code to convert the voice data to text data transmits the text data to a network based service for voice to text conversion.

14. The computer program product of claim 12, wherein each identifier within the list of identifiers is associated with a command for controlling at least one of the applications.

15. The computer program product of claim 14, wherein a name of each application is an identifier that is associated with a command to launch that application.

16. The computer program product of claim 12, wherein the computer readable code to control the at least one of the applications includes at least one of launching and navigating through the application.

17. The computer program product of claim 12, wherein the computer readable code to control the at least one of the applications includes at least one of playing, pausing, stopping, and traversing content.

18. The computer program product of claim 12, further comprising computer readable code to display the text data when the text data is matched to a plurality of identifiers, and receive confirmation from the user that the text data represents the voice data.

19. The computer program product of claim 12, further comprising computer readable code to notify a user if the text data is not matched to an identifier.

20. A device comprising:
a display for displaying one or more applications;
a microphone for detecting voice data; and
a processor coupled to the display, the processor configured to
receive the voice data from the microphone;
convert the voice data to text data;
match the text data to an identifier, the identifier associated with a list of identifiers for controlling operation of at least one of the applications; and
control the at least one of the applications based on the identifier matched with the text data.

21. The device of claim 20, wherein the converting the voice data to text data includes transmitting the text data to a network based service for voice to text conversion.

22. The device of claim 20, wherein voice data for controlling one or more applications is received from a control device.

23. The device of claim 22, wherein the device is one of a television remote, a tablet, a mobile phone, a personal digital assistant, a video player, and a music player.

24. The device of claim 20, wherein each identifier within the list of identifiers is associated with a command for controlling at least one of the applications.

25. The device of claim 24, wherein a name of each of the applications is an identifier that is associated with a command to launch that application.

26. The device of claim 20, wherein the display is configured to display the text data to a user until the processor receives a signal that the text data represents the voice data.

27. The device of claim 20, wherein the processor is further configured to notify a user when the text data is not matched to an identifier.
